(19) United States
(12) Patent Application Publication
(10) Pub. No.: US 2009/0224741 A1
(43) Pub. Date: Sep. 10, 2009

(54) LOW POWER SUPPLY MAINTAINING CIRCUIT

(75) Inventors: Bojko Marholev, Irvine, CA (US); Evan McCarthy, Costa Mesa, CA (US)

Correspondence Address: BRAKE HUGHES BELLERMANN LLP;c/o CPA Global, P.O. Box 52050, Minneapolis, MN, 55402, US

(73) Assignee: BROADCOM CORPORATION, Irvine, CA (US)

(21) Appl. No.: 12/044,726

(22) Filed: Mar. 7, 2008

(51) Int. Cl. G05F 1/44; G05F 1/10

(52) U.S. Cl. 323/283; 323/234; 323/288

(57) ABSTRACT

A circuit may include a load that is configured to enter a low power mode, a capacitor that is operably coupled to the load and that is configured to provide a minimum voltage and current for the load to maintain its state while in the low power mode, a finite state machine that is configured to receive a clock signal and to duty cycle on a periodic basis based on the clock signal and to enable a power-up signal on the periodic basis, and a low-dropout voltage regulator that is operably coupled to the finite state machine and to the capacitor and that is configured to receive the power-up signal from the finite state machine, to power on in response to receiving the power-up signal, to provide a voltage upon power on to the capacitor, and to regulate the voltage to charge the capacitor.

### TECHNICAL FIELD

This description relates to a low power supply maintaining circuit.

### BACKGROUND

The performance of various devices such as, for example, cellular phones, personal digital assistants (PDAs), MP3 players and other types of devices may be measured by their battery life. One factor that may affect a device's battery life performance is current consumption by circuits within the device. Devices may have varying levels of activity and use during the time that the device is powered on. Even during periods of lower activity level, circuits within the device may be consuming power and thus, using up the device battery life.

### SUMMARY

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary circuit diagram of a low power supply maintaining circuit.

FIG. 2 is an exemplary circuit diagram of a low power supply maintaining circuit.

FIG. 3 is an exemplary circuit diagram of a low power supply maintaining circuit.

### DETAILED DESCRIPTION

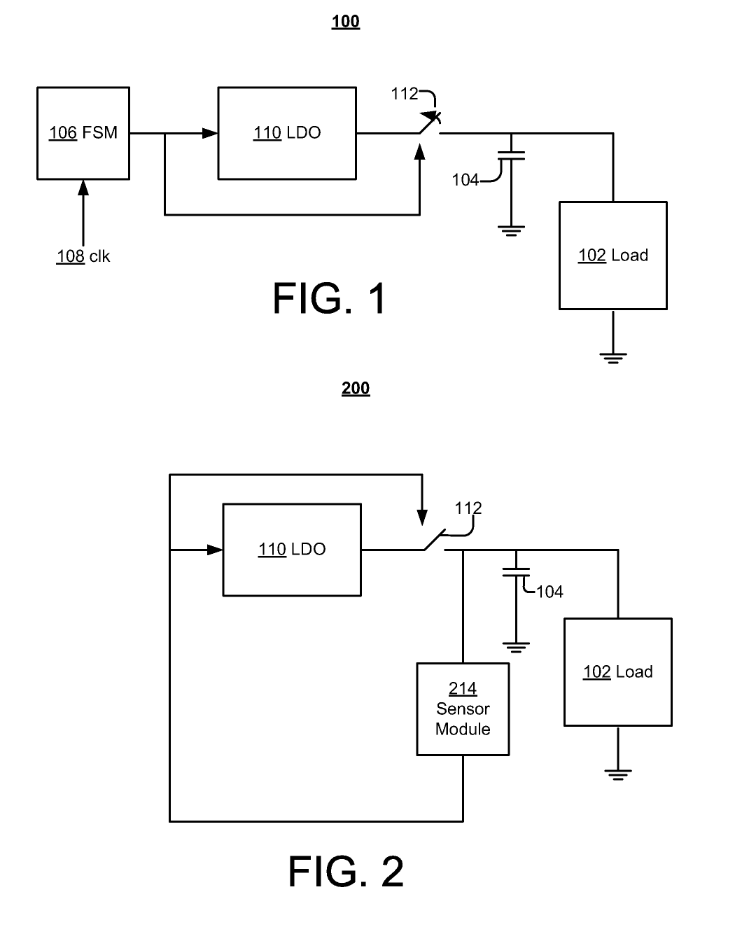

Referring to FIG. 1, an exemplary schematic of a circuit 100 is illustrated. In one exemplary implementation, circuit 100 may be used to provide a voltage and a minimal amount of current that may be needed by a load (e.g., a digital circuit) to maintain its state when the load is in a low power mode.

Circuit 100 may include a load 102, a capacitor 104, a finite state machine (FSM) 106 having a clock input 108, and a voltage regulator such as, for example, a low-dropout voltage regulator (LDO) 110. In one exemplary implementation, the load 102 may include one or more digital circuits. For example, the digital circuits may include digital circuits that may be found in devices such as cellular phones, MP3 players, digital cameras, personal computers including laptop computers and notebook computers, PDAs, and other types of devices. The digital circuits may include, for example, memory circuits, counters, and many other types of digital circuits.

The load 102 may be arranged and configured to have multiple different modes including, for example, a low power mode. The load 102 may enter the low power mode when the load is not in use. For instance, the load 102 may be a digital circuit in a cellular phone. When the cellular phone enters a standby mode or there is a low level of activity on the cellular phone, then the digital circuit may not be needed and may enter a low power mode to conserve power consumption and prolong the battery life for the cellular phone. However, the digital circuit may still consume some minimum amount of current while in low power mode.

The capacitor 104 may be operably coupled to the load 102 and may be arranged and configured to provide a voltage and a minimum level of current for a certain amount of time to the load 102 so that the load 102 can maintain its state while in the low power mode. In one exemplary implementation, the capacitor 104 may represent a load capacitance of the load 102. In another exemplary implementation, the capacitor 104 may include a device capacitor. In another exemplary implementation, the capacitor 104 may include be a combination of a device capacitor and the load capacitance of the load 102.

The FSM 106 may receive a clock signal 108 and may be operably coupled to the LDO 110. The FSM 106 may be arranged and configured to duty cycle on a periodic basis based on the received clock signal 108 and to enable a power-up signal on the periodic basis. For example, the FSM 106 may duty cycle periodically (e.g., every 5 ms) to provide the power-up signal to the LDO 110. The duty cycle of the FSM 106 may be configurable and may be configured based on a type of load 102, the capacitance of the capacitor 104 and the minimum level of current needed by the load 102 to sustain a voltage above a certain level to maintain the state of the load while in a low power mode.

The clock signal 108 may be provided by another component such as an oscillator (e.g., a crystal oscillator) or other component that may provide a clocking signal. The clock signal 108 may be changed and configured to alter the duty cycle of the FSM 106.

The LDO 110 may be operably coupled to the FSM 106 and to the capacitor 104. The LDO 110 may be arranged and configured to receive the power-up signal from the FSM 106. Thus, as the FSM 106 cycles on, then the power-up signal is sent to the LDO 110. The LDO 110 powers on in response to receiving the power-up signal and provides a voltage to the capacitor 104 and regulates the provided voltage to a to charge the capacitor 104. The LDO 110 may be configured to regulate the voltage to a desired voltage level that is necessary to provide a minimum level of current needed by the load 102 to maintain its state while in a low power mode.

When the LDO 110 is not charging the capacitor 104, then the LDO 110 may be powered off and not drawing any current. Thus, the combination of the capacitor 104, the FSM 106 and the LDO 110 enables the load 102 to maintain its state while in a low power mode and to limit the amount of time that these devices are powered on and consuming power.

Although an LDO is illustrated as the voltage regulator, other types of voltage regulators may be used in circuit 100.

Circuit 100 also may include a switch 112 that may be operable coupled to the LDO 110 and to the capacitor 104. The switch 112 may be arranged and configured to close when the LDO 110 is powered on and to open when the LDO 110 is powered off.

In one exemplary implementation, the switch 112 may be optional and may not be included as part of circuit 100. For example, if the LDO 110 provides a high impedance in the off state, the switch 112 may not be included in the circuit.

Referring to FIG. 2, an exemplary schematic of a circuit 200 is illustrated. In one exemplary implementation, circuit 200 may be used to provide a voltage and a minimal amount of current that may be needed by a load (e.g., a digital circuit) to maintain its state when the load is in a low power mode.

Circuit 200 may include a load 102, a capacitor 104, a sensor module 214 and a voltage regulator such as, for example, LDO 110. The load 102 and the capacitor 104 may include the features and functions as described above with respect to FIG. 1.

The sensor module 214 may be operably coupled to the capacitor 104 and to the LDO 110. The sensor module 214 may be arranged and configured to sense when a voltage in the capacitor 104 has reach a low threshold and to enable a power-up signal to be sent to the LDO 110 to power on. The sensor module 214 also may sense when the voltage in the capacitor 104 is charged and to disable the power-up signal such that the LDO 110 is powered off. In this manner, the sensor module 214 may be configured to enable and disable the power-up signal for a range of voltages. The range of voltages may be set such that the capacitor 104 will have enough charge to provide the current that may be needed by the load 102 to maintain its state when the load 102 is in a low power mode.

In one exemplary implementation, the sensor module 214 may include one or more comparators that may be arranged and configured to sense the voltage from the capacitor 104 and to enable and disable the power-up signal. If the sensor module 214 includes two comparators, then only one comparator may be powered on at a time, thus, reducing the amount of current that may be consumed by the sensor module 214.

The LDO 110 may be operably coupled to the sensor module 214 and to the capacitor 104. The LDO 110 may be arranged and configured to receive the power-up signal from the sensor module 214 and power on in response to receiving the power-up signal. When the LDO 110 powers on, the LDO 110 provides a voltage to charge the capacitor 104 and regulates the voltage to a desired level to charge the capacitor 104.

In one exemplary implementation, the sensor module 214 may be set to sense when the voltage in the capacitor 104 droops to 1.0V. When the capacitor 104 droops to 1.0V, the sensor module 214 may enable the power-up signal. The LDO 110 receives the power-up signal, powers on and provides a voltage to charge the capacitor 104.

In this exemplary implementation, the sensor module 214 may be set to sense when the voltage in the capacitor 104 reaches 1.3V When the capacitor 104 is charged to 1.3V, the sensor module 213 may disable the power-up signal. The LDO 110 stops receiving the power-up signal, powers off and stops providing the voltage to the capacitor 104.

Circuit 200 also may include a switch 112 that may be operably coupled to the LDO 110 and to the capacitor 104. The switch 112 may be arranged and configured to close when the LDO 110 is powered on and to open when the LDO 110 is powered off.

In one exemplary implementation, the switch 112 may be optional and may not be included as part of the circuit 200. For example, if the LDO 110 provides a high impedance in the off state, the switch 112 may not be included in the circuit.

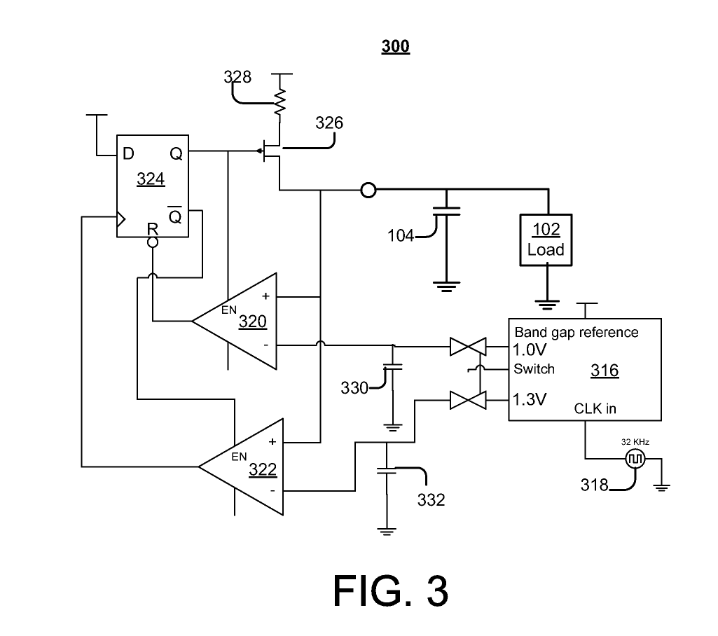

Referring to FIG. 3, an exemplary schematic of a circuit 300 is illustrated. In one exemplary implementation, circuit 300 may be used to provide a voltage and a minimal amount of current that may be needed by a load (e.g., a digital circuit) to maintain its state when the load is in a low power mode.

Circuit 300 may include a load 102, a capacitor 104, a band gap reference module 316 having a clock signal 318, a first comparator 320, a second comparator 322, a flip-flop 324, and a field effect transistor (FET) 326. Circuit 300 also may include a resistor 328, a capacitor 330 and a capacitor 332. The load 102 and the capacitor 104 may include the features and functions as described above with respect to FIG. 1.

The band gap reference module 316 may be arranged and configured to receive a clock signal 318 and to provide a low voltage reference and a high voltage reference. The band gap reference module 316 may be configurable such that the low voltage reference and the high voltage reference may be set at different levels. For example, the low and the high voltage reference levels may be set to match a range of voltages that the capacitor 104 should remain within in order to provide the current necessary for the load 102 to maintain its state while in a low power mode. While FIG. 3 illustrates a 1.0V low voltage reference and a 1.3V high voltage reference for the band gap reference module 316, these voltage levels are merely provided as examples.

The capacitor 330 and the capacitor 332 may be operably coupled to the band gap reference module 316. The capacitor 330 may be operably coupled to the first comparator 320 and may be configured to store the low voltage reference. The capacitor 332 may be operably coupled to the second comparator 322 and may be configured to store the high voltage reference. In this manner, the band gap reference module 316 may charge the respective capacitors 330 and 332 to the appropriate voltage reference levels and then may power off. Thus, the band gap reference module 316 does not always need to remain powered on and may consume less current than if it were always on.

The clock signal 318 may be configured to duty cycle the band gap reference module 316. In one exemplary implementation, the duty cycle operation of the band gap reference module 316 may mean that the band gap reference module 316 may only need to operate 1/30 of the time. Yet, with the capacitors 330 and 332, the reference charges are maintained and provided for the first comparator 320 and the second comparator 322.

The first comparator 320 and the second comparator 322 may be operably coupled to the band gap reference module 316 and to the capacitor 104. The first comparator 320 may be arranged and configured to sense a voltage of the capacitor 104. When the voltage in the capacitor 104 reaches the low voltage reference point, then the first comparator 320 may be enabled and turned on. The output of the first comparator 320 may be coupled to the flip-flop 324 and, more specifically, may be coupled to the reset input of the flip-flop 324.

In one exemplary implementation, the flip-flop 324 may be a reset able D flip-flop. The flip-flop 324 may be operably coupled to the FET 326 such that the flip-flop drives the FET 326, which is operably coupled to the capacitor 104 to charge the capacitor 104. Thus, when the first comparator 320 is enabled and turned on, then the flip-flop 324 is reset and drives the FET 326 to charge the capacitor 104.

The second comparator 322 may be arranged and configured to sense a voltage of the capacitor 104. When the voltage in the capacitor 104 reaches the high voltage reference point, then the second comparator 322 may be enabled and turned on. The first comparator 320 may be turned off. The output of the second comparator 322 may be coupled to the flip-flop 324 and, more specifically, may be coupled to the clock input of the flip-flop 324. Thus, when the second comparator 322 is enabled and turned on, then the flip-flop 324 may be clocked and the FET 326 may be turned off and stop charging the capacitor 104. In this manner, only one of the comparators 320 and 322 may need to be on at the same time.

In one exemplary implementation, the FET 326 may be a positive channel field effect transistor (pFET). The FET 326 may be operably coupled to the flip-flop 324 and to the capacitor 104. The FET 326 may be arranged and configured to charge the capacitor 104 when the first comparator 320 is turned on. The FET 326 may be arranged and configured to stop charging the capacitor 104 when the second comparator 322 is turned on.

The resistor 328 may be coupled to the FET 326. The resistor 328 may be arranged and configured to reduce switching noise in the circuit 300 and may limit the current at which the FET 326 provides a charge to the capacitor 104. The resistor 328 also enables the first comparator 320 and the second comparator 322 to operate slower because they won't need to react as quickly to changes in the charge to the capacitor 104.

In general, the amount of current consumed by circuit 300 essentially is about the current consumption of one of the comparators. The use of the resistor 328 enables the other components to remain off for longer periods of time.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations.

What is claimed is:

1. A circuit comprising:
a load that is arranged and configured to enter a low power mode;
a capacitor that is operably coupled to the load and that is arranged and configured to provide a minimum voltage and current for the load to maintain its state while in the low power mode;
a finite state machine that is arranged and configured to receive a clock signal and to duty cycle on a periodic basis based on the clock signal and to enable a power-up signal on the periodic basis; and
a low-dropout voltage regulator that is operably coupled to the finite state machine and to the capacitor and that is arranged and configured to:
receive the power-up signal from the finite state machine,
power on in response to receiving the power-up signal,
provide a voltage upon power on to the capacitor, and
regulate the voltage to charge the capacitor.

2. The circuit of claim 1 wherein the load includes digital circuitry.

3. The circuit of claim 1 wherein the load includes a memory module.

4. The circuit of claim 1 wherein the load includes a counter.

5. The circuit of claim 1 wherein the capacitor is a load capacitance of the load.

6. The circuit of claim 1 wherein the finite state machine is arranged and configured to duty cycle on a configurable periodic basis based on the clock signal and to generate the power-up signal on the periodic basis.

7. The circuit of claim 1 further comprising:
a switch that is operably coupled to the low-dropout voltage regulator and the capacitor and that is arranged and configured to close when the low-dropout voltage regulator is powered on and to open when the low-dropout voltage regulator is powered off.

8. A circuit comprising:
a load that is arranged and configured to enter a low power mode;
a capacitor that is operably coupled to the load and that is arranged and configured to provide a minimum voltage and current for the load to maintain its state while in the low power mode;
a sensor module that is operably coupled to the capacitor and that is arranged and configured to:
sense when a voltage in the capacitor is low and to enable a power-up signal, and
sense when the voltage in the capacitor in charged and to disable the power-up signal; and
a low-dropout voltage regulator that is operably coupled to the sensor module and to the capacitor and that is arranged and configured to:
receive the power-up signal from the sensor module,
power on in response to receiving the power-up signal,
provide a voltage upon power on to the capacitor, and
regulate the voltage to a desired level to charge the capacitor.

9. The circuit of claim 8 wherein the load includes digital circuitry.

10. The circuit of claim 8 wherein the load includes a memory module.

11. The circuit of claim 8 wherein the load includes a counter.

12. The circuit of claim 8 wherein the capacitor is a load capacitance of the load.

13. The circuit of claim 8 further comprising:
a switch that is operably coupled to the low-dropout voltage regulator and the capacitor and that is arranged and configured to close when the low-dropout voltage regulator is powered on and to open when the low-dropout voltage regulator is powered off.

14. A circuit comprising:
a load that is arranged and configured to enter a low power mode;
a first capacitor that is operably coupled to the load and that is arranged and configured to provide a minimum voltage and current for the load to maintain its state while in the low power mode;
a band gap reference module that is arranged and configured to receive a clock signal and to provide a low voltage reference and a high voltage reference;
a first comparator that is operably coupled to the band gap reference module and to the first capacitor and that is arranged and configured to sense a voltage of the first capacitor and to turn on when the voltage of the first capacitor reaches the low voltage reference;
a second comparator that is operably coupled to the band gap reference module and to the first capacitor and that is arranged and configured to sense the voltage of the first capacitor and to turn on when the voltage of the first capacitor reaches the high voltage reference;
a flip-flop, wherein:
a reset input of the flip-flop is operably coupled to an output of the first comparator, and
a clock input of the flip-flop is operably coupled to the second comparator, and
a field effect transistor (FET) that is operably coupled to the flip-flop and to the first capacitor and that is arranged and configured to charge the first capacitor when the first comparator is turned on and to stop charging the first capacitor when the second comparator is turned on.

15. The circuit of claim 14 wherein the load includes digital circuitry.

16. The circuit of claim 14 wherein the first capacitor is a load capacitance of the load.

17. The circuit of claim 14 wherein the FET is a positive channel field effect transistor (pFET).

18. The circuit of claim 14 further comprising:
a resistor that is operably coupled to the FET and that is arranged and configured to reduce noise in the circuit and to limit a speed at which the FET provides a charge to the capacitor.

19. The circuit of claim 14 further comprising:
a second capacitor that is operably coupled to the band gap reference module and to the first comparator and that is arranged and configured to store a charge associated with the low voltage reference; and
a third capacitor that is operably coupled to the band gap reference module and to the second comparator and that is arranged and configured to store a charge associated with the high voltage reference.

20. The circuit of claim 14 wherein only one of the first comparator and the second comparator is on at a same time.
